(19) United States
(12) Patent Application Publication
(10) Pub. No.: US 2023/0046048 A1
(43) Pub. Date: Feb. 16, 2023

(54) COMPOSITE-TYPE TEMPERATURE RAISING AND CONTROL INTEGRATED HEATING ELEMENT AND TEMPERATURE CONTROL METHOD

(71) Applicant: SHENZHEN BUDDY TECHNOLOGY DEVELOPMENT CO., LTD., Shenzhen (CN)

(72) Inventors: Hui LI, Shenzhen (CN); Xiang LIU, Shenzhen (CN)

(73) Assignee: SHENZHEN BUDDY TECHNOLOGY DEVELOPMENT CO., LTD., Shenzhen (CN)

(21) Appl. No.: 17/793,048

(22) PCT Filed: Jan. 15, 2021
(86) PCT No.: PCT/CN2021/072120

§ 371 Date: Jul. 15, 2022

(30) Foreign Application Priority Data
Jan. 17, 2020 (CN) 202010054217.6

(51) Int. Cl. A24F 40/46; A24F 40/51; A24F 40/57

(52) U.S. Cl. CPC A24F 40/46; A24F 40/51; A24F 40/57

(57) ABSTRACT

A composite-type temperature raising and control integrated heating element and a temperature control method are provided. The heating element includes a heating body, which is integrated by welding two different conductive materials at a welding point. The heating element is not provided with a temperature measuring element other than the heating body. The heating body of the temperature raising and control integrated heating element is formed by welding two conductive materials. When a high voltage is applied, the two conductive materials serve as the heating body to generate heat. When the supply of the voltage is stopped, the two conductive materials serve as a thermocouple temperature measuring sensor to measure the temperature of the heating element. Compared to existing heating elements, the temperature measuring sensor is omitted, the fabrication process of the heating element is simplified, and the performance of the heating element is improved.

### CROSS REFERENCE TO THE RELATED APPLICATIONS

This application is the national phase entry of International Application No. PCT/CN2021/072120, filed on Jan. 15, 2021, which is based upon and claims priority to Chinese Patent Application No. 202010054217.6, filed on Jan. 17, 2020, the entire contents of which are incorporated herein by reference.

### TECHNICAL FIELD

The present invention belongs to the technical field of a heating element of new smoking implement and, especially relates to a composite-type temperature raising and control integrated heating element and a temperature control method.

### BACKGROUND

In the prior art, a heating element of a smoking implement for heat-not-burn tobacco rolls realizes heating and temperature measuring by providing a heating wire and a thermocouple on the heating element’s main body. The heating element is prone to short-circuit because the heating wire and the thermocouple are arranged closely. Moreover, the process of producing the heating element is complicated. Additionally, a heating circuit and a temperature measuring circuit are designed separately, leading to an overall complex circuit.

### SUMMARY

In order to solve the above-mentioned problem, the present invention is provided.

In the first aspect, the present invention provides a composite-type temperature raising and control integrated heating element. The heating element includes a heating body, which is integrated by welding two different conductive materials at a welding point. The heating element is not provided with a temperature measuring element other than the heating body.

The two metal or alloy materials after being welded are configured to heat up under energized conditions, and serve as a thermocouple temperature measuring sensor for temperature measuring when not under energized conditions.

The position of the welding point can be selected according to the temperature field distribution of the heating element. Usually, the position of the welding point is the high-temperature position of the entire heating element.

Preferably, the two different conductive materials include two different metals or two different alloys, or one of the two materials is a metal and the other is an alloy.

Preferably, the shape of the heat element includes a sheet structure, a rod structure, or a cup structure, and the heating body is provided on the hollow interior or the outer wall of the sheet structure, the rod structure, or the cup structure.

Preferably, the heating element further includes a shell.

The shell is provided with a hollow cavity.

The heating body is provided within the hollow cavity of the shell.

Two heating circuit pins protruding out of the shell are provided at ends of the heating body.

Preferably, the structure of the heating body includes a spiral winding structure, a segmented spiral winding structure, or a broken line structure.

Preferably, the two different conductive materials of the heating body include one of the following three combinations: a platinum-rhodium alloy and a platinum, a nickel-chromium alloy and a nickel-silicon alloy, and a nickel-chromium-silicon alloy and the nickel-silicon alloy.

Preferably, the inner wall of the hollow cavity of the shell is provided with an insulating layer.

Preferably, the material of the shell is selected from a ceramic, a metal, a metal oxide, or an alloy material.

The shape of the shell is a hollow cylinder shape with a tip, or a sword shape.

Preferably, the shell may be formed by pressing multiple pieces together, or may be formed integrally.

Preferably, the heating element further includes a base, and the base is arranged at the bottom part of the heating element. The base is configured to immobilize and protect the heating body.

In the second aspect, the present invention provides a temperature control method of the composite-type temperature raising and control integrated heating element. The heating element in the first aspect is electrically connected to the anode and the cathode of a circuit control device by the two heating circuit pins of the heating element. The temperature control method includes the following steps:
Step A: adjusting the circuit control device to supply the heating element with a first voltage V₀ . At this time, current passes through the heating body, and the heating body heats up as a heating body to achieve temperature control.
Step B: adjusting the circuit control device to stop supplying the voltage for the heating element. At this time, the heating body serves as a thermocouple temperature measuring sensor to detect the temperature of the heating element to achieve temperature detection.

Preferably, a process of the temperature control and the temperature detection is periodically achieved through the circuit control device by periodically adjusting the voltage supplied to the heating body in a predetermined time.

The above-mentioned technical solutions can be freely combined under the precondition that the combination does not contradict.

The present invention has the following advantages.

The present invention provides designs for a temperature raising and control integrated heating element inventively, and a new method for temperature control of a heating element for the heat-not-burn tobacco rolls. The heating body is formed by welding two conductive materials. When a high voltage is applied, the two conductive materials serve as the heating body to generate heat. When supply of the voltage is stopped, the two conductive materials serve as a thermocouple temperature measuring sensor to measure the temperature of the heating element. Compared to existing heating elements, the temperature measuring sensor is omitted, the fabrication process of the heating element is simplified, the performance of the heating element is improved, the roasting effect of tobacco rolls is improved, the production costs are reduced, and a better user experience is brought to consumers.

### BRIEF DESCRIPTION OF THE DRAWINGS

FIG. 1 is a schematic diagram of a composite-type temperature raising and control integrated heating element in Embodiment I.

FIG. 2 is a temperature control and detection signal waveform diagram of composite-type temperature raising and control integrated heating element in Embodiment II.

### NUMERALS SYMBOLS IN THE FIGURES

1-heating element, 2-shell, 3-welding point, 4-heating body, 5-base, and 6-heating circuit pin.

### DETAILED DESCRIPTION OF THE EMBODIMENTS

The present invention is further described in conjunction with the following embodiments.

### Embodiment I

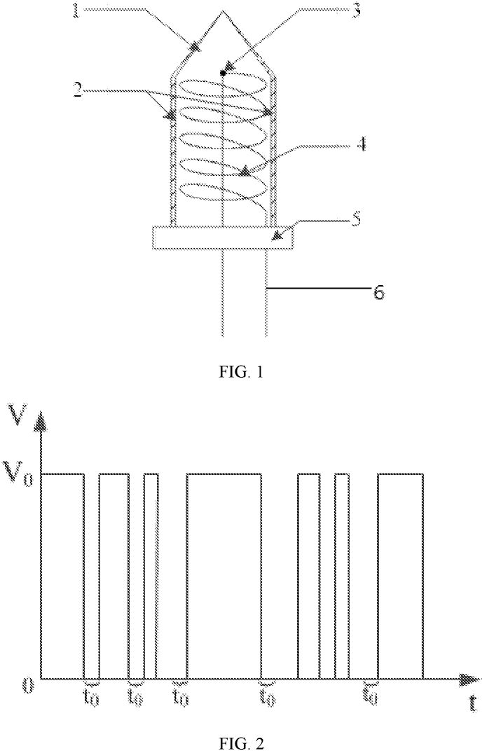

As shown in FIG. 1, the composite-type temperature raising and control integrated heating element 1 includes a shell 2, a welding point 3, a heating body 4, and a base 5. The heating element 1 is not provided with a temperature measuring element other than the heating body 4.

The heating element 1 is in a rod shape with a tip. The shell 2 is formed by pressing two metal sheets together. The borders of the two sheets are pressed to be sealed, and a cavity is formed in the center. The heating body 4 is arranged in the cavity. The heating body 4 is integrated by welding two different alloy materials of nickel-chromium alloy and nickel-silicon alloy at the welding point 3. The heating body 4 has a threadlike structure in the form of a spiral winding, and two heating circuit pins 6 protruding out of the shell 2 and the base 5 are provided at the ends of the heating body 4. The base 5 is provided at the bottom of the heating element 1.

### Embodiment II

In a temperature measuring method for the composite-type temperature raising and control integrated heating element, the heating element 1 described in Embodiment I is electrically connected to the anode and the cathode of a circuit control device by the two heating circuit pins 6 of the heating element 1. The temperature control method includes the following steps.

As shown in FIG. 2, during temperature control (in the state where the voltage is equal to the battery voltage), the temperature of the heating element 4 is controlled by adjusting the supplied voltage to the heating body 4 through a pulse-width modulation (PWM) regulation electronic switch. During temperature detection (in the state where the voltage is 0), the heating body 4 tests the temperature of the heating element in time t₀.

The above-mentioned embodiments are only specific implementations of the present invention, but the scope of protection of the present invention is not limited to these embodiments. Any variation or replacement that can be easily thought of by any person skilled in the art within the technical scope disclosed by the present invention shall be covered in the scope of protection of the present invention. Therefore, the scope of protection of the present invention shall be subject to the scope of protection of the claims.

What is claimed is:

1. A composite-type temperature raising and control integrated heating element, comprising a heating body, wherein the heating body is integrated by welding two different conductive materials at a welding point ; and the heating element is not provided with a temperature measuring element other than the heating body.

2. The composite-type temperature raising and control integrated heating element according to claim 1, wherein the two different conductive materials comprise two different metals or two different alloys, or one of the two different conductive materials is a metal and the other of the two different conductive materials is an alloy.

3. The composite-type temperature raising and control integrated heating element according to claim 1, wherein a shape of the heat element comprises a sheet structure, a rod structure, or a cup structure; and the heating body is provided on a hollow interior or an outer wall of the sheet structure, the rod structure, or the cup structure.

4. The composite-type temperature raising and control integrated heating element according to claim 1, further comprising a shell;
wherein the shell is provided with a hollow cavity;
the heating body is provided within the hollow cavity of the shell; and
two heating circuit pins protruding out of the shell are provided at ends of the heating body.

5. The composite-type temperature raising and control integrated heating element according to claim 1, wherein a structure of the heating body comprises a spiral winding structure, or a segmented spiral winding structure, or a broken line structure.

6. The composite-type temperature raising and control integrated heating element according to claim 1, wherein the two different conductive materials of the heating body comprise one of the following three combinations: a platinum-rhodium alloy and a platinum metal, a nickel-chromium alloy and a nickel-silicon alloy, and a nickel-chromium-silicon alloy and the nickel-silicon alloy.

7. The composite-type temperature raising and control integrated heating element according to claim 4, wherein an inner wall of the hollow cavity of the shell is provided with an insulating layer.

8. The composite-type temperature raising and control integrated heating element according to claim 4, wherein a material of the shell is selected from a ceramic, a metal, a metal oxide, or an alloy material.

9. A temperature control method of a composite-type temperature raising and control integrated heating element, wherein the composite-type temperature raising and control integrated heating element according to claim 1 is electrically connected to an anode and a cathode of a circuit control device by two heating circuit pins of the composite-type temperature raising and control integrated heating element; and the temperature control method comprises the following steps:
step A: adjusting the circuit control device to supply the composite-type temperature raising and control integrated heating element with a first voltage V₀ ; wherein at this time, a current passes through the heating body, and the heating body heats up as a heating body to achieve temperature control; and
step B: adjusting the circuit control device to stop supplying the voltage for the composite-type temperature raising and control integrated heating element; wherein at this time, the heating body serves as a thermocouple temperature measuring sensor to detect a temperature of the composite-type temperature raising and control integrated heating element to achieve temperature detection.

10. The temperature control method according to claim 9, wherein a process of the temperature control and the temperature detection is periodically achieved through the circuit control device by periodically adjusting the voltage supplied to the heating body in a predetermined time.
